(19) United States
(12) Patent Application Publication
(10) Pub. No.: US 2011/0138321 A1
(43) Pub. Date: Jun. 9, 2011

(54) ZONE-BASED FUNCTIONS IN A USER INTERFACE

(75) Inventors: Lloyd W. Allen, JR., Cary, NC (US); Travis M. Grigsby, Austin, TX (US); Jana H. Jenkins, Raleigh, NC (US); Steven M. Miller, Cary, NC (US)

(73) Assignee: INTERNATIONAL BUSINESS MACHINES CORPORATION, Armonk, NY (US)

(21) Appl. No.: 12/631,275

(22) Filed: Dec. 4, 2009

(51) Int. Cl. G06F 3/048

(52) U.S. Cl. 715/786

(57) ABSTRACT

Initiating a predefined function responsive to detecting a selected graphic control moved into a zone within a user interface. One or more zones may be defined, and a corresponding function is defined for each zone. Responsive to movement of the selected graphic control in an orthogonal direction and releasing the control in a particular zone, a particular function is invoked, the particular function corresponding to the zone in which the control is released.

### BACKGROUND OF THE INVENTION

The present invention relates to computing environments, and deals more particularly with initiating a predefined function responsive to detecting a selected graphic control moved into a zone within a user interface.

Scroll bars are common controls used in the user interface of computer applications to provide a way to navigate through content in a display window, where the size of the content exceeds the currently-visible portion of the display window. A tremendous volume of data is sometimes available to users in today's environment, particularly when considering the content available from the Internet. Consequently, users sometimes spend a considerable amount of time scanning through the content and interacting with the content display. Use of conventional scroll bars may become cumbersome.

### BRIEF SUMMARY OF THE INVENTION

The present invention is directed to providing zone-based functions in a user interface. In one embodiment, this comprises defining at least one zone for the user interface and for each defined zone, a corresponding function; and responsive to detecting a selected graphic control moved into a particular one of the at least one defined zone in an orthogonal direction of movement, invoking the function corresponding to the particular zone. As one example, the selected graphic control may be an elevator control of a scroll bar displayed on the user interface, in which case moving the selected graphic control may comprise dragging a ghosted image of the elevator control. As another example, the selected graphic control may be a progress indicator displayed by a media player. Detecting the selected graphic control moved into the particular zone may comprise detecting a user moving a finger across a finger-operated user interface.

Invoking the function may be further responsive to detecting release of the selected graphic control in the particular zone. The invoked function may comprise, by way of example, increasing granularity of scrolling of a scroll bar from which the selected graphic control is selected; highlighting at least a portion of the user interface; or performing a character count of characters displayed within at least a portion of the user interface and then (optionally) displaying the character count on the user interface. Optionally, an area to which the invoked function will apply may be defined, the area being different from the particular zone.

Optionally, the definition of at least one defined zone and/or the function corresponding to at least one defined zone may be altered. Optionally, a location within the user interface of each of the at least one defined zone may be visually indicated on the user interface.

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 depicts a sample user interface window according to the prior art;

FIG. 2 depicts a window with a single zone for providing a zone-based function, according to an embodiment of the present invention;

FIG. 3 illustrates a “ghosted” image of an elevator control, signifying that a user has selected the elevator control with a pointing device and then dragged the selected control to invoke a zone-based function;

FIG. 4 shows how the displayed content of FIG. 1 changes, responsive to operation of a sample zone-based function that increases scroll granularity;

FIGS. 5 and 6 depict a window with a two zones and three zones, respectively, for providing multiple zone-based functions, according to an embodiment of the present invention;

FIG. 7 shows how the displayed content of FIG. 1 changes, responsive to operation of a sample zone-based function that applies visual highlighting to an area of the user interface window, and FIG. 8 shows how the displayed content of FIG. 1 changes responsive to a different zone-based function that performs character counting;

FIGS. 9 and 11 provide flowcharts depicting logic which may be used when implementing an embodiment of the present invention, and FIG. 10 depicts a sample data structure that stores information created and used according to the logic in these flowcharts, respectively;

FIG. 12 depicts a data processing system suitable for storing and/or executing program code; and

FIG. 13 depicts a representative networking environment in which one or more embodiments of the present invention may be used.

### DETAILED DESCRIPTION OF THE INVENTION

When viewing a portion of content that exceeds the visible display space of a user interface, users often need to interact with the content in addition to scrolling the display to show some different portion of the content, to work with multiple scroll bars, and/or to copy content into a different application. Use of conventional scroll bars may become cumbersome.

Embodiments of the present invention are directed toward providing additional capabilities for scroll bars or other controls, whereby users can initiate predefined functions responsive to detecting a selected graphic control moved into a zone within a user interface. These additional capabilities include, by way of illustration but not of limitation, zooming, highlighting, character counting, and modifying the scrolling granularity. Zone-based functions according to the present invention may be invoked by selecting a graphic control displayed on a user interface and dragging that graphic control in a direction that is orthogonal to a direction in which the graphic control is moved for conventional functions. (The orthogonal direction may generally comprise a direction that is perpendicular to the conventional direction, although it is not required that the orthogonal direction comprises an exact 90-degree difference from the conventional direction. An embodiment of the present invention may be adapted for detecting movement in a direction that is sufficiently different from the conventional direction of movement as to convey a user's desire to invoke zone-based functions.)

In one embodiment, zone-based functions are activated by dragging of the so-called “elevator” control of a scroll bar in a direction orthogonal to the conventional movement direction of that elevator control. (As used herein, the terms “elevator” and “elevator control” refer to the movable graphic with which a user changes the visible display portion by dragging the graphic up or down on a vertically-positioned scroll bar, or left and right on a horizontally-positioned scroll bar. This control is sometimes referred to as a “slider” or “slider bar”.)

In one aspect, a ghosted image of the elevator control is provided when the user engages the elevator control by selection thereof with a pointing device (such as a mouse cursor), and this ghosted image can then be dragged from the scroll bar responsive to performing a dragging operation on the selected elevator control. When using a vertical scroll bar, this ghosted image is dragged to the left or right in order to activate a predefined function according to an embodiment of the present invention, and when using a horizontal scroll bar, the ghosted image is dragged up or down in order to activate a predefined function according to an embodiment of the present invention. For either type of scroll bar, the existing functionality of scrolling the content responsive to conventional movement of the elevator control remains intact. (Use of a ghosted image is one way in which a user can visually detect that zone-based functionality is being invoked. However, use of a ghosted image is not required and other approaches may be used without deviating from the scope of the present invention.)

A number of zones may be predefined for use with an embodiment of the present invention, and a particular one of the predefined functions is then invoked based on which of the zones the ghosted image of the elevator control is dragged into when the control is released. Zones and predefined functions may be configured for use with an embodiment of the present invention, providing flexibility in which zone corresponds to a particular predefined function (as will be discussed in more detail herein).

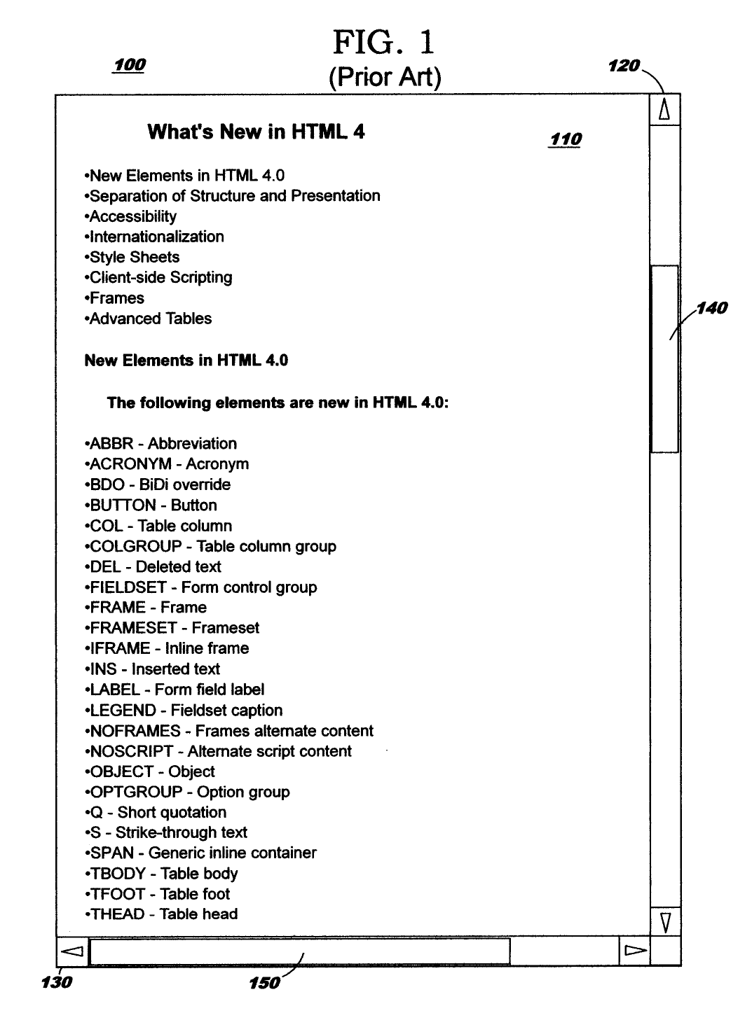

Suppose, by way of illustration, that a user is scrolling downward through a large document by moving the elevator control downward on a vertical scroll bar. See, for example, the sample user interface window 100 in FIG. 1. As is well known, presence of the vertical scroll bar 120 visually signifies to the user that additional content is available at the top and/or bottom of the displayed content portion 110, and the location of the elevator control 140 within the vertical scroll bar 120 visually signifies an approximate location of the displayed content portion 110 within the complete underlying document. As is also well known, the size of the elevator control 140 relative to the size of the vertical scroll bar 120 indicates an approximate relative size of the displayed content portion 110 as compared to the size of the complete underlying document. Similarly, presence of the horizontal scroll bar 130 visually signifies that additional content is available to the left and/or right of the displayed content portion 110. In the example of FIG. 1, the elevator control 150 is positioned at the far left of the horizontal scroll bar 130, visually indicating that no further content is present in the underlying document, in a horizontal direction, prior to the displayed content portion 110. The user can change the portion of the document which is visible within window 100, for example by selecting elevator control 140 and dragging it up or down, or by selecting elevator control 150 and (in this example) dragging it to the right.

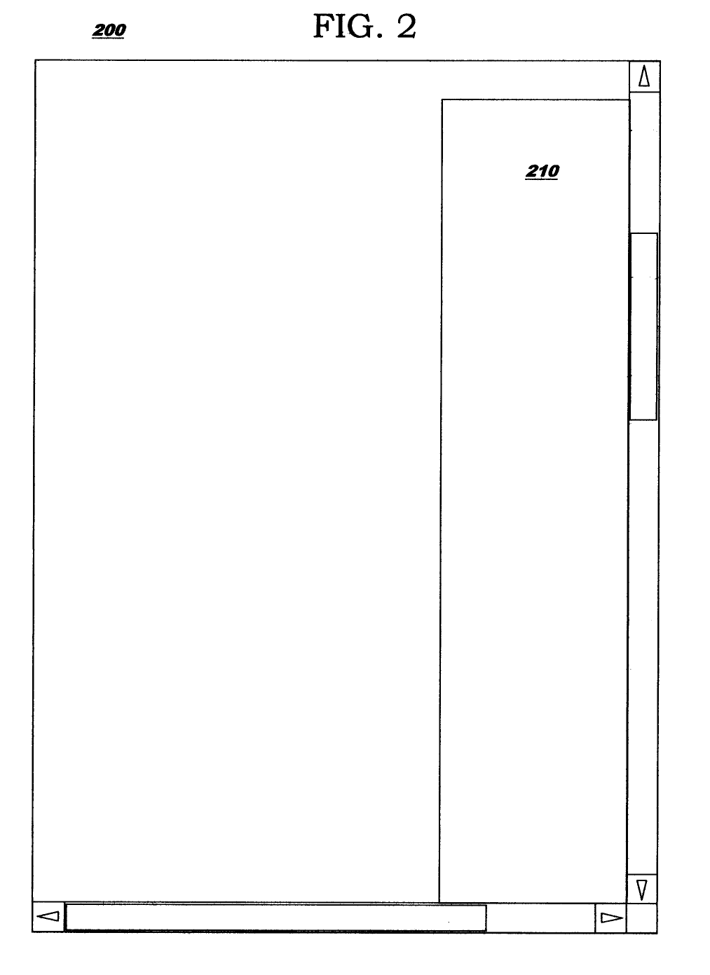

When using an embodiment of the present invention, the user interface window is configured to have at least one logical zone overlaid thereupon. This logical zone may be represented as overlaying some part of the content portion of the window (i.e., the portion of the window that excludes the scroll bars) or as overlaying some part of the overall window. FIG. 2 depicts a window 200 with a single zone 210. The window 200 corresponds, in this example, to overlaying window 100 of FIG. 1 with zone 210 (where the content 110 has been removed in order to better illustrate the presence of the zone 210) according to an embodiment of the present invention.

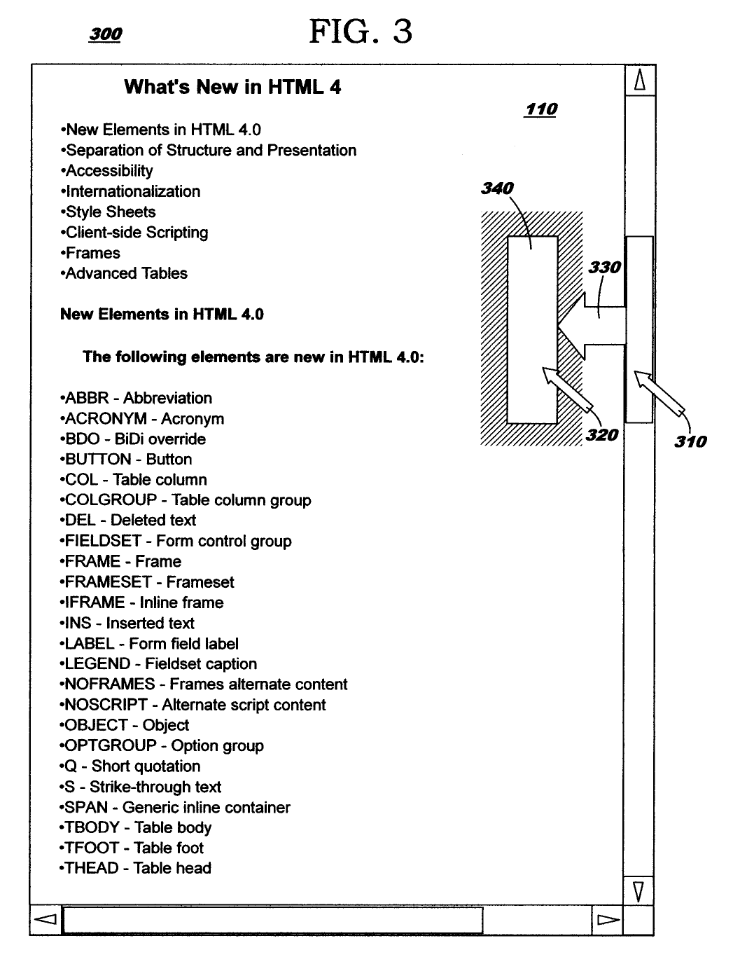

Referring now to FIG. 3, a ghosted image 340 of elevator control 140 is depicted, signifying that the user has selected elevator control 140 with a pointing device in order to drag the selected control 140. In the example scenario illustrated in FIG. 3, the dragging is in a leftward direction, and selecting is shown by arrows 310, 320 and the leftward movement is shown by arrow 330. It should be understood that arrows 310, 320 are provided in FIG. 3 for illustrating that the selecting preferably comprises pressing the pointing device at 140 and continuing to press the pointing device throughout the dragging of the ghosted image 340, and arrow 330 is provided in FIG. 3 for illustrating the dragging operation of ghosted image 340 from selected control 140. These arrows 310, 320, 330 are preferably not displayed to the user when using an actual embodiment of the present invention.

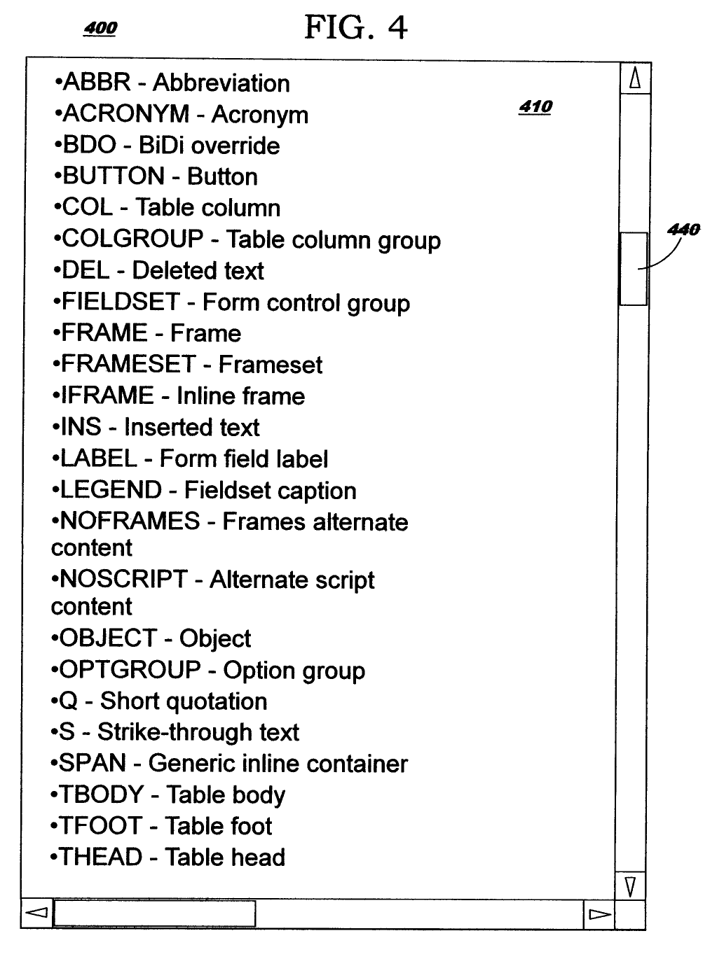

Suppose that the user viewing the content portion 110 drags the ghosted image 340 some number of pixels in a leftward direction, and then releases the pointing device. An embodiment of the present invention detects the release and then determines whether a zone is defined for the location at which the release occurs. If the release occurs in zone 210 of FIG. 2, for example, then the function defined for that zone is invoked. As one example, the predefined function may be to increase the granularity of the vertical scrolling within window 100. FIG. 4 shows a resulting change to the displayed content 410, which is now displayed in a larger font (as compared to FIG. 1). In addition, the relative size of elevator control 440 is smaller than control 140. Thus, for a particular amount of movement of control 440, the scrolling of the underlying document is finer-grained than when using the same amount of movement with control 140.

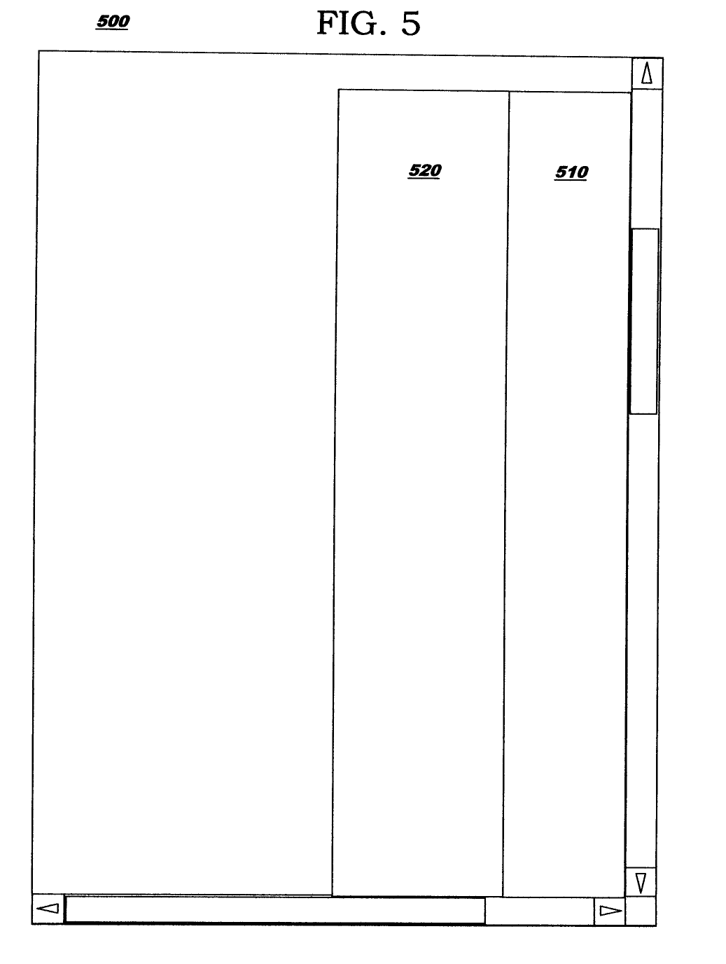

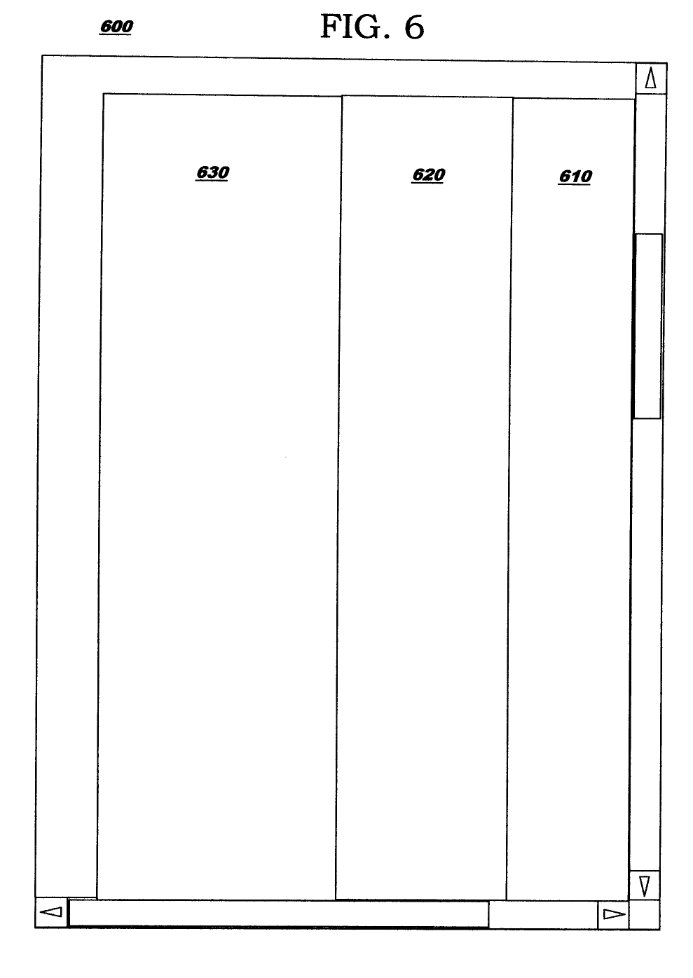

FIG. 5 depicts a window 500 with two zones 510, 520, and FIG. 6 depicts a window 600 with three zones 610, 620, 630. The number of zones defined for a window, and the placement of those zones, may vary, and while the zones shown in FIGS. 2, 5, and 6 are defined for use with a vertical scroll bar, zones may additionally or alternatively be defined for use with a horizontal scroll bar. Accordingly, the sample windows, zones, and functions depicted herein are presented by way of illustration but not of limitation.

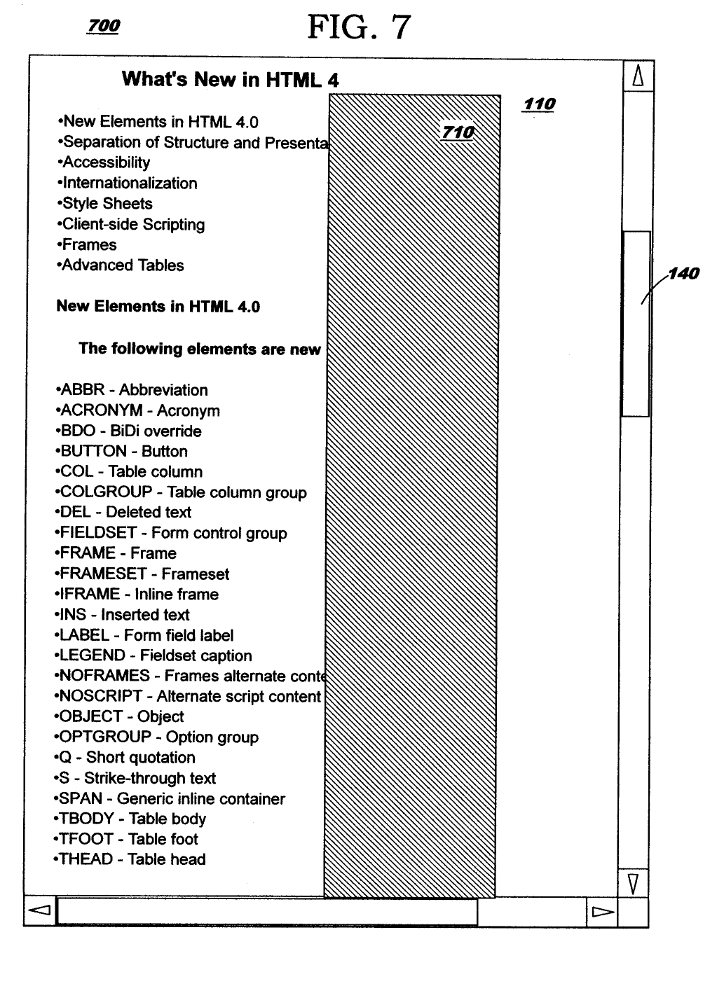

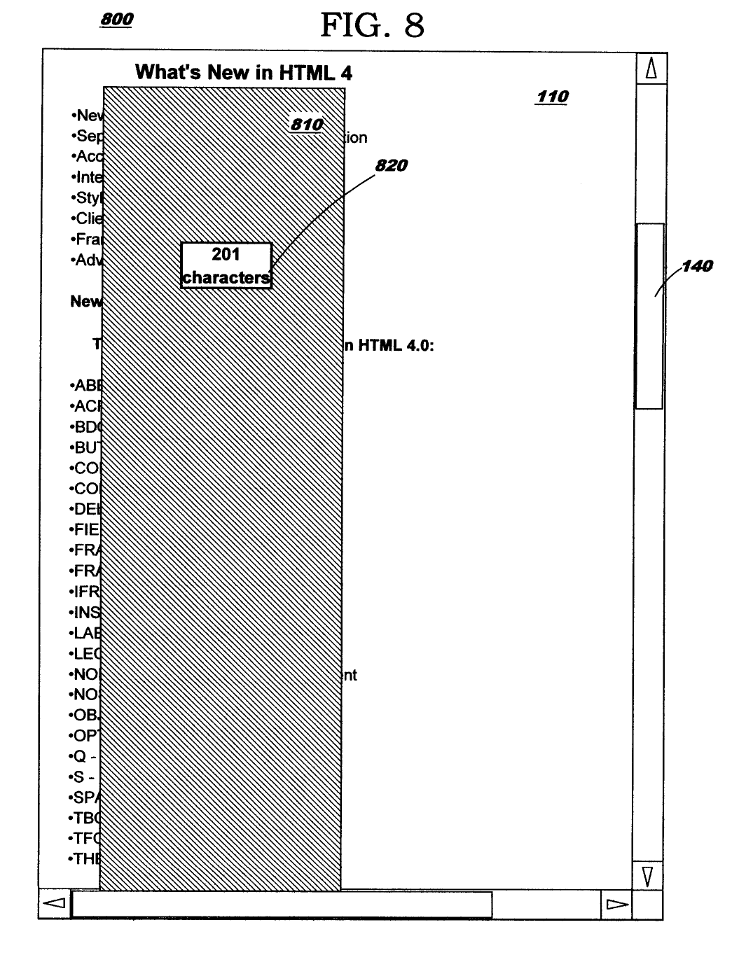

Continuing now with the example discussed earlier, suppose that the first zone 510 in FIG. 5 corresponds to the increased granularity of scrolling as discussed above and that the function defined for the second zone 520 is highlighting. If the user selects elevator control 140 and drags the ghosted image 340 through zone 510 and into zone 520 before the release of the pointing device, the highlighting function is invoked (and the granularity increase function is not invoked, in this scenario). See FIG. 7, which shows a resulting change to the displayed content 710. For drafting convenience, the highlighting is represented using diagonal hash marks. Note also that in actual usage, the text within the highlighted area would normally be visible through the highlighting; however, for drafting convenience, the highlighted area is shown in FIG. 7 as an opaque rectangle. In one aspect, the highlighting is automatically applied to the area of window 700 that corresponds to the zone in which the pointing device is released. In another aspect, the release of the ghosted image 340 initiates the highlighting function, which then awaits user selection of an area to be highlighted. For example, the user might right-click the pointing device to signify that the subsequent movement of the pointing device will define the area, and the user might then left-click the pointing device and continue pressing the pointing device while drawing a selection rectangle around a block of text or other graphics.

When using the display window 600 of FIG. 6, the first and second zones 610, 620 may correspond to the increased granularity and highlighting functions which have been discussed. Further suppose that the function defined for the third zone 630 is character counting. If the user selects elevator control 140 and drags the ghosted image 340 through zones 610, 620 and into zone 630 before the release of the pointing device, the character counting function is invoked (and neither the granularity increase function or the highlighting function is invoked, in this scenario). See FIG. 8, which shows a resulting change to the displayed content 810 that comprises adding a graphic 820 which indicates the count of the characters currently displayed in the zone in which the pointing device is released. The zone may be visually highlighted, as shown in FIG. 8 at 810 using diagonal hash marks. In one aspect, as illustrated by FIG. 8, the counting is automatically applied to all of the characters currently displayed in the zone in which the pointing device is released. In another aspect, the counting is automatically applied to the entire area of window 800, such that all of the characters are included in the count. In this aspect, graphic 820 may be provided without visually highlighting of the type used at 810. In yet another aspect, the release of the ghosted image 340 initiates the character counting function, which then awaits user selection of an area for which the characters will then be counted. For example, the user might right-click the pointing device to signify that the subsequent movement of the pointing device will define the area, and the user might then left-click the pointing device and continue pressing the pointing device while drawing a selection rectangle around a block of text.

As previously noted, the functions that correspond to the zones may be configured, and may be dependent on factors such as the particular application displaying the user interface window. For example, when using a word processing application, one set of functions may be desirable, whereas when using a different type of application, additional or different functions may be desirable. It may be desirable to offer frequently-requested functions in zones closer to the scroll bar, with less-commonly-requested functions offered farther out. Zone borders may be displayed to the user. The display of the borders may be done using color, lines, grid overlay, etc.

In an alternative embodiment, the zone-based functions may be invoked responsive to detecting a selected graphic control entering a zone responsive to movement that does not pertain to a scroll bar and/or responsive to movement that does not originate from dragging an elevator control. Several examples will now be described.

As one example, media player applications commonly include a graphic that visually indicates the span of the media and the current position of play within that span, and the graphic typically changes visually as the media plays. Zone-based functions may be invoked by selecting this graphic and then dragging it in a direction that is orthogonal to the direction in which the graphic changes to show progress within the underlying media. For example, assuming the conventional visual change to the graphic is to alter the color in a rightward direction, a zone-based function may be invoked by dragging up or down after selecting the graphic with a pointing device. Zone-based functions in this scenario may comprise adjusting the volume at which the audio portion of the media is played, zooming the video portion of the media, and so forth.

As another example, zone-based functions may be provided on an iPhone® device or other similar device with a finger-operated user interface. (“iPhone” is a registered trademark of Apple Inc. in the United States, other countries, or both.) Suppose the currently-active application is configured for conventional vertical scrolling of content. Invoking zone-based functions as disclosed herein may then comprise the user pressing his finger onto the iPhone user interface and then moving his finger to the left or right while keeping it pressed (noting, in this example, that the left and right movement is orthogonal to the vertical scrolling direction defined for conventional scrolling). Optionally, the user interface may visually display zone indicators. When the user releases his finger in a particular zone, the predefined function corresponding to that zone may be invoked in a manner analogous to that which has been discussed above. Flicking up and down, in an application that provides conventional vertical scrolling, continues to operate as usual. For an application that provides conventional horizontal scrolling, zone-based functions may be invoked by the user moving his finger up and down (in which case flicking left and right continues to operate as usual). Zone-based functions in this scenario may comprise adjusting the flick granularity, hopping between groups, and so forth.

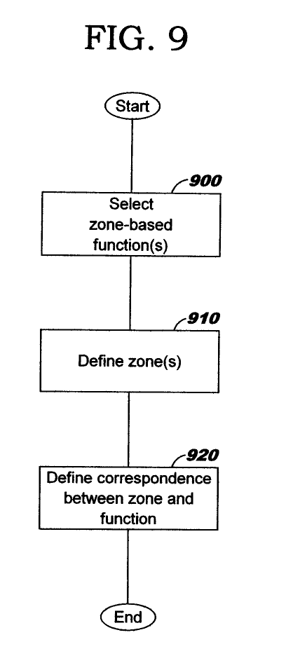

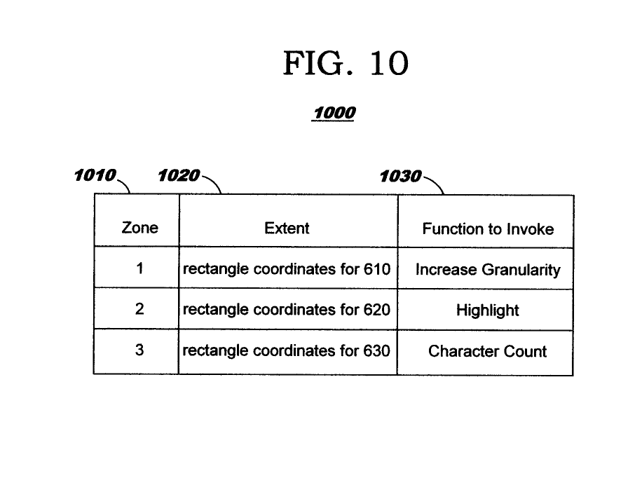

FIG. 9 provides a flowchart depicting logic which may be used when configuring an embodiment of the present invention. At Block 900, the particular zone-based function or functions to be used with this embodiment is/are selected. A library of functions may be available, for example, and appropriate ones of those available functions may be selected. At Block 910, each of the zones to be used with this embodiment is defined. Coordinates of the zones may be specified, for example, to correspond to an overlay for a user interface window. In this case, the coordinates may be defined in relative terms or as physical coordinates. A correspondence between zone and function is then defined at Block 920. The processing of FIG. 9 then exits.

FIG. 10 provides a data structure that may be used for storing the correspondence between zones and functions. In this example, the data structure is shown as a table 1000, although this is by way of illustration and not of limitation. The sample table 1000 represents the zones and corresponding functions which were discussed above with reference to FIG. 6. Thus, column 1010 contains an identifier for each zone; column 1020 contains the extent of that zone; and column 1030 contains an identifier of the corresponding function. In this example, the extent information in column 1020 indicates that the coordinates of a rectangle defining the area of the zone would be provided, although actual coordinate information for the extents has not been shown in the example table 1000.

The correspondence between zones and functions may be altered, after the initial configuration, by modifying the entries in the data structure. Thus, for example, fewer zones could be provided by deleting a row or rows from the sample data structure 1000. The ordering of the zones could be changed by altering the extent information in column 1020; the function corresponding to a particular zone could be changed by altering the information in column 1030; and so forth.

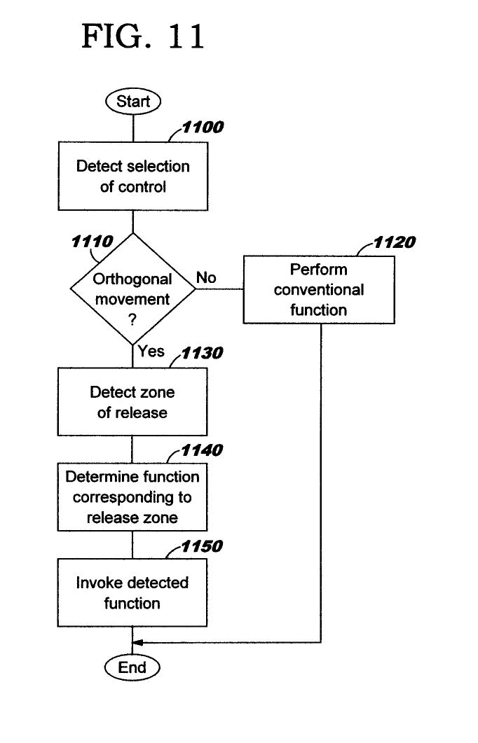

FIG. 11 provides a flowchart depicting logic which may be used at run time to implement zone-based functions as disclosed herein. Block 1100 detects selection of a graphic control, such as the elevator control discussed above. Block 1110 tests whether the control is being moved in an orthogonal manner. As noted above, orthogonal movement of a vertical scroll bar or other vertical control comprises movement in a (generally) horizontal direction, and orthogonal movement of a horizontal scroll bar or other horizontal control comprises movement in a (generally) vertical direction. When the test at Block 1110 has a negative result, control transfers to Block 1120 where the conventional function (i.e., the function corresponding to the non-orthogonal movement) is performed, after which the processing of FIG. 11 exits. When the test at Block 1110 has a positive result, on the other hand, processing continues at Block 1130. Block 1130 awaits the release of the pointing device, and then determines in which zone the release occurs. Block 1140 determines the function corresponding to the release zone, and that function is then invoked at Block 1150. Processing of FIG. 11 then exits.

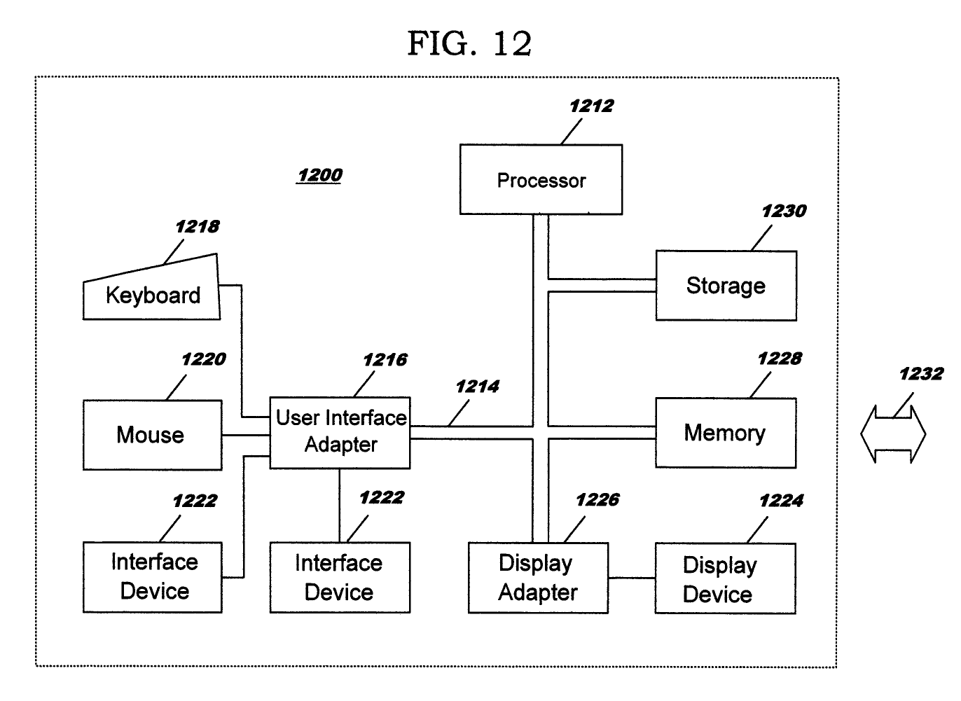

Referring now to FIG. 12, a data processing system 1200 suitable for storing and/or executing program code includes at least one processor 1212 coupled directly or indirectly to memory elements through a system bus 1214. The memory elements can include local memory 1228 employed during actual execution of the program code, bulk storage 1230, and cache memories (not shown) which provide temporary storage of at least some program code in order to reduce the number of times code must be retrieved from bulk storage during execution.

Input/output (“I/O”) devices (including but not limited to keyboards 1218, displays 1224, pointing devices 1220, other interface devices 1222, etc.) can be coupled to the system either directly or through intervening I/O controllers or adapters (1216, 1226).

Network adapters may also be coupled to the system to enable the data processing system to become coupled to other data processing systems or remote printers or storage devices through intervening private or public networks (as shown generally at 1232). Modems, cable modem attachments, wireless adapters, and Ethernet cards are just a few of the currently-available types of network adapters.

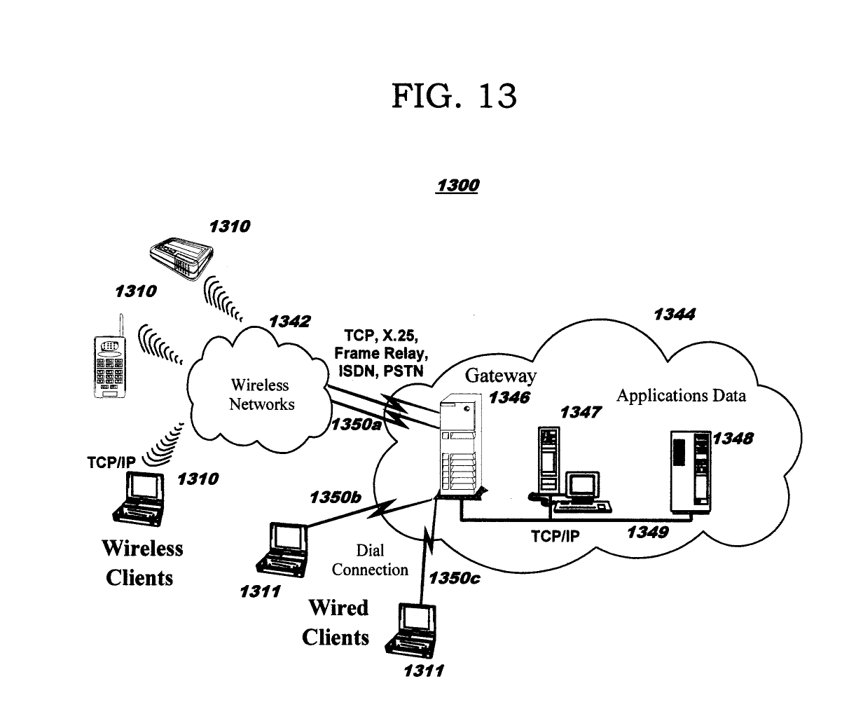

FIG. 13 illustrates a data processing network environment 1300 in which the present invention may be practiced. The data processing network 1300 may include a plurality of individual networks, such as wireless network 1342 and wired network 1344. A plurality of wireless devices 1310 may communicate over wireless network 1342, and a plurality of wired devices, shown in the figure (by way of illustration) as workstations 1311, may communicate over network 1344. Additionally, as those skilled in the art will appreciate, one or more local area networks (“LANs”) may be included (not shown), where a LAN may comprise a plurality of devices coupled to a host processor.

Still referring to FIG. 13, the networks 1342 and 1344 may also include mainframe computers or servers, such as a gateway computer 1346 or application server 1347 (which may access a data repository 1348). A gateway computer 1346 serves as a point of entry into each network, such as network 1344. The gateway 1346 may be preferably coupled to another network 1342 by means of a communications link 1350a. The gateway 1346 may also be directly coupled to one or more player devices 1311 using a communications link 1350b, 1350c, and/or may be indirectly coupled to such devices. The gateway computer 1346 may be implemented utilizing an Enterprise Systems Architecture/390® computer available from IBM. Depending on the application, a midrange computer, such as an Application System/400® (also known as an AS/400®), iSeries®, System i™, and so forth may be employed. (“Enterprise Systems Architecture/390”, “Application System/400”, “AS/400”, and “iSeries” are registered trademarks of IBM in the United States, other countries, or both, and “System i” is a trademark of IBM.)

The gateway computer 1346 may also be coupled 1349 to a storage device (such as data repository 1348).

Those skilled in the art will appreciate that the gateway computer 1346 may be located a great geographic distance from the network 1342, and similarly, the player devices 1310a, 1311a and/or other devices 1310b, 1311b may be located some distance from the networks 1342 and 1344, respectively. For example, the network 1342 may be located in California, while the gateway 1346 may be located in Texas, and one or more of the player devices 1310a may be located in Florida. The player devices 1310a may connect to the wireless network 1342 using a networking protocol such as the Transmission Control Protocol/Internet Protocol (“TCP/IP”) over a number of alternative connection media, such as cellular phone, radio frequency networks, satellite networks, etc. The wireless network 1342 preferably connects to the gateway 1346 using a network connection 1350a such as TCP or User Datagram Protocol (“UDP”) over IP, X.25, Frame Relay, Integrated Services Digital Network (“ISDN”), Public Switched Telephone Network (“PSTN”), etc. The player devices 1311a may connect directly to the gateway 1346 using dial connections 1350b or 1350c. Further, the wireless network 1342 and network 1344 may connect to one or more other networks (not shown), in an analogous manner to that depicted in FIG. 13.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on the user's playback device and partly on a remote computer associated with the rental media provider. The remote computer may be connected to the user's playback device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A method for providing zone-based functions in a user interface, comprising using a processor of a computer for:
defining at least one zone for the user interface and for each defined zone, a corresponding function; and
responsive to detecting a selected graphic control moved into a particular one of the at least one defined zone in an orthogonal direction of movement, invoking the function corresponding to the particular zone.

2. The method according to claim 1, wherein the selected graphic control is an elevator control of a scroll bar displayed on the user interface.

3. The method according to claim 2, wherein moving the selected graphic control comprises dragging a ghosted image of the elevator control.

4. The method according to claim 1, wherein the selected graphic control is a progress indicator displayed by a media player.

5. The method according to claim 1, wherein detecting the selected graphic control moved into the particular zone comprises detecting a user moving a finger across a finger-operated user interface.

6. The method according to claim 1, wherein the invoking is further responsive to detecting release of the selected graphic control in the particular zone.

7. The method according to claim 1, wherein the invoked function comprises increasing granularity of scrolling of a scroll bar from which the selected graphic control is selected.

8. The method according to claim 1, wherein the invoked function comprises highlighting at least a portion of the user interface.

9. The method according to claim 1, wherein the invoked function comprises performing a character count of characters displayed within at least a portion of the user interface and displaying the character count on the user interface.

10. The method according to claim 1, further comprising defining an area to which the invoked function will apply, the area being different from the particular zone.

11. The method according to claim 1, wherein the selected graphic control is an elevator control of a vertical scroll bar displayed on the user interface and the orthogonal direction of movement comprises moving the selected graphic control in a horizontal direction.

12. The method according to claim 1, wherein the selected graphic control is an elevator control of a horizontal scroll bar displayed on the user interface and the orthogonal direction of movement comprises moving the selected graphic control in a vertical direction.

13. A system for providing zone-based functions in a user interface, comprising:
a computer comprising a processor; and
instructions which are executable, using the processor, to implement functions comprising:
defining at least one zone for the user interface and for each defined zone, a corresponding function; and
responsive to detecting a selected graphic control moved into a particular one of the at least one defined zone in an orthogonal direction of movement, invoking the function corresponding to the particular zone.

14. The system according to claim 13, wherein the selected graphic control is an elevator control of a scroll bar displayed on the user interface and moving the selected graphic control comprises dragging a ghosted image of the elevator control.

15. The system according to claim 13, wherein:
detecting the selected graphic control moved into the particular zone comprises detecting a user moving a finger across a finger-operated user interface; and
the orthogonal direction of movement comprises the user moving the finger in a direction orthogonal to a direction defined for invoking other function in the finger-operated user interface.

16. The system according to claim 13, wherein the invoking is further responsive to detecting release of the selected graphic control in the particular zone.

17. A computer program product for providing zone-based functions in a user interface, the computer program product comprising:
a computer readable storage medium having computer readable program code embodied therein, the computer readable program code configured for:
defining at least one zone within the user interface and for each defined zone, a corresponding function; and
responsive to detecting a selected graphic control moved into a particular one of the at least one defined zone in an orthogonal direction of movement, invoking the function corresponding to the particular zone.

18. The computer program product according to claim 17, wherein the computer readable program code is further configured for altering the definition of at least one defined zone.

19. The computer program product according to claim 17, wherein the computer readable program code is further configured for altering the function corresponding to at least one defined zone.

20. The computer program product according to claim 17, wherein the computer readable program code is further configured for visually indicating a location, within the user interface, of each of the at least one defined zone.
